(19) United States
(12) Patent Application Publication
(10) Pub. No.: US 2026/0221687 A1
(43) Pub. Date: Jul. 30, 2026

(54) VIBRATION-REDUCING PLUG CONNECTOR SUPPORT ELEMENT, PLUG SYSTEM AND PLUG CONNECTION

(71) Applicant: TE Connectivity Solutions GmbH, Schaffhausen (CH)

(72) Inventors: Kevin SCHEER, Schaffhausen (CH); Harald ULRICH, Schaffhausen (CH)

(21) Appl. No.: 19/459,481

(22) Filed: Jan. 26, 2026

(30) Foreign Application Priority Data
Jan. 25, 2025 (DE) 102025103011.1

(51) Int. Cl. H01R 13/56; H01R 13/502; H01R 13/508; H01R 13/533

(52) U.S. Cl. CPC H01R 13/565; H01R 13/5025; H01R 13/508; H01R 13/533

(57) ABSTRACT

A plug connector support element is provided for supporting a plug on a mating plug arrangement connected to the plug, wherein the plug connector support element is designed to be mounted externally between the plug and the mating plug arrangement. The plug connector support element includes at least one plug support surface designed to rest on the outside of the plug, and at least one counter support surface opposite the at least one plug support surface, designed to rest on the outside of the mating plug arrangement. A plug system with such a plug connector support element and a plug connection with such a plug system are provided. The proposed means contribute to making plug connections more robust against relative movements between the plug and the mating plug arrangement and less susceptible to wear.

### CROSS REFERENCE TO RELATED APPLICATIONS

This application claims the benefit of DE Application No. 102025103011.1, filed 28 Jan. 2025, the subject matter of which is herein incorporated by reference in its entirety.

### BACKGROUND OF THE INVENTION

The subject matter herein relates to a plug connector support element for an electrical plug connector, a plug system with such a plug connector support element, and a plug connection with such a plug system.

Electrical plug connections usually have a plug and a mating plug arrangement that can be connected to it. When assembled, in vibration-prone environments, such as in vehicles, the connection between the plug and the mating plug arrangement can be subjected to high stress, for example, when the plug and the mating plug arrangement move relative to each other. Such stress can also occur if work is carried out in the vicinity of the plug connection and the plug and/or mating plug arrangement is accidentally touched. Over time, this stress can increase the play between the plug and the mating plug arrangement, causing the plug connection to wear and compromising the secure electrical connection between the plug and the mating plug arrangement.

There is a need for taking measures to make a plug connection less susceptible to wear.

### BRIEF DESCRIPTION OF THE INVENTION

In one embodiment, a plug connector support element is provided for supporting a plug on a mating plug arrangement mated with the plug, wherein the plug connector support element is configured to be mounted externally between the plug and the mating plug arrangement, and wherein the plug connector support element includes at least one plug support surface configured to rest externally on the plug, and at least one counter support surface opposite the at least one plug support surface, which counter support surface is configured to rest externally on the mating plug arrangement.

The plug connector support element can absorb forces and moments exerted on the plug, for example by heavy cables of the plug, via the at least one plug support surface and transfer them to the mating plug arrangement via the at least one counter support surface. When the plug connector support element is mounted between the plug and the mating plug arrangement, it can absorb at least some of the forces and/or torques transmitted from the plug to the mating plug arrangement. This relieves in particular the interface between the plug and the mating plug arrangement, which at least reduces the occurrence of play between the plug and the mating plug arrangement and thus relative movements and vibrations. At the same time, the plug connector support element is easy to mount on the plug connector, as it can be attached to the plug connector externally.

The subject matter herein can be further improved by the following features, each of which is advantageous in itself and can be combined with each other as desired.

The mating plug arrangement may comprise a mating plug that can be connected to the plug and/or a unit in which the mating plug may be or is at least sectionally mounted, in particular a wall of the unit. In particular, the mating plug arrangement may be formed by the mating plug and/or the unit, in particular the wall of the unit. Such a unit may, for example, be a battery or a motor or a component of the battery or motor. The unit is preferably a component separate from the plug and mating plug.

The fact that the plug connector support element can be attached externally between the plug and the mating plug arrangement can be understood in particular to mean that the plug connector support element can be mounted completely externally to a housing of the plug and completely externally to a housing of the mating plug arrangement, in particular to a housing of the mating plug and/or to a housing of the unit. The plug connector support element can thus be mounted to an outer side of the plug or, respectively, the mating plug arrangement, in particular to an outer side of the housing of the plug or, respectively, the housing of the mating plug arrangement. In particular, the plug connector support element may not penetrate into the interior of the plug and the mating plug arrangement so that the tightness of the plug connector is maintained.

The plug connector support element may in particular be arranged in the force flow between the plug and the mating plug arrangement. The force flow is present, for example, when the plug and/or the mating plug arrangement is subjected to forces and/or moments. Such loads can occur, for example, due to contact, vibrations, plugging operations or the weight forces of the plug or a cable connected to the plug.

The plug can be supported on the mating plug arrangement via the plug connector support element, or the mating plug arrangement can be supported on the plug via the plug connector support element, respectively.

The counter support surface of the plug connector support element may be designed in particular to rest on the mating plug and/or on the unit, in particular on the wall of the unit. The plug can be supported via the plug connector support element on the mating plug and/or on the unit, in particular on the wall of the unit.

In one embodiment, a projection in the mating direction of the at least one counter support surface may lie at least partially, but preferably completely, within a projection in the mating direction of the at least one plug support surface.

In order to support moments exerted by the plug on the plug connector support element at the mating plug arrangement and to be able to block relative movement between the plug and the mating plug arrangement in at least one further direction when the plug connector support element is attached to the plug connector, the plug connector support element may have at least one torque support surface arranged at an angle to the at least one plug support surface and/or to the at least one counter support surface.

The at least one torque support surface can be designed in particular to transfer eccentric loads, such as tilting loads of the plug, to the mating plug arrangement. An eccentric load may be present, for example, if the plug has a plugging section that can be connected to the mating plug arrangement and a connecting section that protrudes transversely from the plugging section and is subjected to a force. The connecting section can form a lever arm, as a result of which the force exerts a moment on the interface between the plug and the mating plug arrangement.

The at least one torque support surface can be designed to bear against the mating plug arrangement and to support forces and/or moments exerted by the plug on the plug connector support element at least partially on the mating plug arrangement.

The at least one torque support surface may be designed to bear against the mating plug and/or the unit, in particular against the wall of the unit, and to support forces and/or moments exerted by the plug on the plug connector support element at least partially on the mating plug and/or the unit. This relieves the interface between the plug and the mating plug arrangement.

The at least one torque support surface may extend perpendicular to the plug support surface and/or perpendicular to the counter support surface.

In order to transfer the forces and/or moments exerted by the plug on the at least one plug support surface to the torque support surface and to increase the stability of the plug connector support element, the plug connector support element may have a support rib extending from the at least one plug support surface to the at least one torque support surface.

The support rib, in particular a plane spanned by the support rib, may extend perpendicular to the at least one plug support surface and/or perpendicular to the at least one counter support surface and/or perpendicular to the at least one torque support surface.

Alternatively or cumulatively, the at least one support rib may extend between the at least one plug support surface and the at least one counter support surface.

In one embodiment, each plug support surface and/or each counter support surface may be arranged on the support rib, for example on an outer edge of the support rib. In a particularly stable embodiment, the support rib is preferably designed to be continuous, i.e. it has no recesses, in particular no openings.

In one embodiment, an inclination angle measured clockwise between the mating direction and the bevel, in particular an outer edge of the bevel, may be between approximately 30° and approximately 60°. The term “approximately” may be understood to mean a deviation of 5°.

The support wall may essentially have the shape of a prism, in particular a three-sided prism, whereby a height of the prism may correspond to the material thickness of the plug connector support element in the area of the support wall.

In order to transfer the forces and/or moments exerted by the plug particularly well to the torque support surface, the support rib may be inclined on at least one side relative to the at least one plug support surface and to the at least one torque support surface and may extend from the at least one plug support surface to the at least one torque support surface. In one embodiment, the support rib may extend from an end of the at least one plug support surface facing away from the torque support surface towards the torque support surface.

The support rib may be inclined at an inclination angle relative to the at least one plug support surface, which is preferably between approximately 15° and approximately 45°. The support rib may essentially have the shape of a prism, in particular a three-sided prism. The height of the prism may correspond to a material thickness of the support rib.

In a particularly stable, especially rigid design, the plug connector support element may have at least one further support rib arranged parallel to the support rib, and a plate connecting the at least one support rib to the at least one further support rib. In particular, planes spanned by the support ribs, i.e. by the support rib and the at least one further support rib, may extend parallel to one another. Preferably, the support ribs, i.e. the support rib and the at least one further support rib, are identically designed. Several further support ribs, for example two or five further support ribs, may be present.

The plate, in particular a plane spanned by the plate, may extend perpendicular to the support ribs, in particular to the planes spanned by the support ribs. The plane may extend alternatively or cumulatively along the at least one plug support surface and/or along the at least one counter support surface.

When the present document refers generally to “support ribs”, this may refer to the support rib and the at least one further support rib.

In order to increase the area at which the plug connector support element rests against the plug and thus improve the force transmission into the plug connector support element, the at least one plug support surface may be formed at least in sections, but preferably completely, by the plate. The plate may be designed to rest flat against the plug.

In order to improve the handling of the plug connector support element and to save material, the plate and/or at least one support rib from the group of support ribs comprising the support rib and the at least one further support rib may have at least one material cutout. The at least one material cutout is preferably designed as an opening, in particular as a through opening. The at least one material cutout may have a round, in particular circular, cross-section. In one embodiment, a longitudinal axis of the material cutout may extend along a normal direction of the at least one plug support surface.

In some embodiments, several material cutouts may be provided. The material cutouts may be arranged in different areas of the plug connector support element, so that one material cutout is arranged in the plate, for example, and another material cutout is arranged in a support rib.

According to a further advantageous embodiment, the at least one plug support surface may protrude beyond the at least one counter support surface. This design of the connector support element is particularly well suited for electrical connectors whose plugs protrude or project beyond the mating plug arrangement.

The at least one plug support surface may protrude beyond the at least one counter support surface on a side of the at least one plug support surface facing away from the at least one torque support surface.

According to a particularly robust and easy-to-manufacture design, the plug connector support element can be monolithically formed. Preferably, the plug connector support element is manufactured by injection moulding. Materials such as single-component materials, in particular thermoplastics such as polyamide (PA) or polybutylene terephthalate (PBT), are suitable. The plug connector support element may have at least one section made of a fiber-reinforced, in particular glass fiber-reinforced plastic (GRP).

The material thickness of the plug connector support element can be between approximately 1 mm and 3 mm. In one embodiment, the material thickness of the plug connector support element can be constant at every point. For example, the material thickness of the at least one plate can correspond to the material thickness of the at least one support rib.

In order to counteract vibrations particularly effectively, the plug connector support element may, according to a further embodiment, be at least sectionally be made from a vibration-damping material. A damping coefficient of the section made from the vibration-damping material may be higher than the damping coefficient of the material of the remaining plug connector support element not made from the vibration-damping material. The section made of the vibration-damping material can be elastic and, for example, made of a rubber material or comprise a rubber material. In one embodiment, the section made of the vibration-damping material can be arranged in the area of the at least one plug support surface, the at least one counter support surface or the at least one torque support surface.

In order to be able to attach the plug connector support element securely, in particular in a loss-proof manner, to the plug or to the mating plug arrangement, the plug connector support element may have at least one form-fit element for connection to the plug and/or the mating plug arrangement. The connection may in particular be understood to mean a locking mechanism. The at least one form-fit element is preferably designed to be detachable and re-attachable to the plug or mating plug arrangement.

A particularly reliable connection between the plug connector support element and the plug or mating plug arrangement can be achieved if the at least one form-fit element is built a as a locking means. The locking means may, for example, comprise a pawl, a locking bolt, a locking hook or a locking groove.

A structurally simple and robust form-fit connection is achieved if, according to one embodiment, the at least one form-fit element is formed by a protrusion that is designed to engage in a recess of the plug or mating plug arrangement that is complementary to this protrusion and/or if the at least one form-fit element is formed by a recess which is designed to engage with a projection of the plug or the mating plug arrangement which is complementary to this recess. The recess may, for example, be designed as a groove, a recess, a corner or a depression. The projection and/or the recess may have an undercut.

The plug connector support element may have several, for example two or three, form-fit elements. The form-fit elements may be identical in design. Nevertheless, at least two form-fit elements may be different, so that one form-fit element is designed, for example, as a locking hook and another form-fit element as a protrusion. Similarly, each form-fit element may be arranged on the same element of the plug connector support element, for example both on a support rib or both on a plate. Nevertheless, at least two form-fit elements may be positioned on different elements of the plug connector support element.

The at least one form-fit element is preferably arranged on or in the area of the at least one plug support surface.

In one embodiment, at least one support surface from the group of support surfaces comprising the at least one plug support surface and the at least one counter support surface may be arranged at least in sections on a form-fit element of the plug connector support element. For example, the at least one plug support surface may be arranged on a form-fit element of the plug connector support element designed as a protrusion.

The task is also solved by a plug system with an electrical plug that is designed to be mateable with a mating plug arrangement in a mating direction, and with at least one plug connector support element, wherein the at least one plug support surface rests externally on the plug at a support surface of the plug, the support surface facing in the mating direction. Such a support surface ensures good force transmission between the plug and the plug connector support element.

According to a further embodiment, the plug may have a plugging section which receives plug contacts, and a cable connecting section which receives at least one cable and projects from the plugging section transversely to the mating direction, wherein the at least one plug support surface rests externally on the cable connecting section of the plug. Due to the cable connecting section projecting transversely to the mating direction, large torques can be exerted on the interface between the plug and the mating plug arrangement, in particular by heavy high-voltage cables. Since the plug connector support element rests against the cable connecting section of the plug, these moments can be supported particularly well by being introduced into the plug connector support element.

In one embodiment, the plug connector support element may have at least one form-fit element for connection to the plug and/or the mating plug arrangement.

In order to attach the at least one form-fit element securely, in particular in a loss-proof manner, to the plug, the at least one form-fit element may, according to a further embodiment, be form-fittingly connected to the plug.

The task is further solved by a plug connection with a plug system, wherein the plug of the plug system is connected to the mating plug arrangement, and wherein the at least one counter support surface rests externally on the mating plug arrangement. In this embodiment, the plug and the mating plug arrangement are connected to each other in a pressure-resistant manner via the plug connector support element. In this way, the forces acting on the plug can be transmitted at least partially via the at least one countersupport surface. This reduces the load on the interface between the plug and the mating plug arrangement.

In an advantageous embodiment, the at least one torque support surface may rest externally on the mating plug arrangement. In this way, at least part of the torques to which the plug is subjected is transmitted via the at least one torque support surface and not via the interface between the plug and the mating plug arrangement. This relieves the interface, reduces relative movements between the plug and the mating plug arrangement and thus vibrations during operation.

In order to secure the at least one form-fit element to the mating plug arrangement in a safe manner, in particular in a loss-proof manner, the at least one form-fit element may, according to one embodiment, be form-fittingly connected to the mating plug arrangement, in particular by means of a snap-fit connection.

The counter support surface and the plug support surface can converge at a reception angle and form a corner in which the mating plug arrangement is received in two spatial directions. One spatial direction can, for example, extend in the mating direction, and the other spatial direction can extend perpendicular to the mating direction and/or perpendicular to a longitudinal axis of the cable. The reception angle is preferably 90°.

In one embodiment, the counter support surface and/or the torque support surface may rest externally on the unit, in particular on the wall of the unit. In this way, the plug is supported by the unit, which further relieves the interface between the plug and the mating plug arrangement.

In this document, a “support surface” or “support surfaces” refer to the at least one plug support surface or the at least one counter support surface.

The mating direction can extend from the plug to the mating plug arrangement, in particular to the mating plug. Preferably, the mating plug arrangement is stationary during plugging, while the plug is moved in the mating direction towards the mating plug arrangement or inserted into or placed on it.

The invention is explained in more detail below with reference to the accompanying figures. Individual features present in the following embodiment may be omitted if, according to the above embodiments, the technical effect associated with this feature is not important. Conversely, a feature described above but not present in a subsequent embodiment may be added to the embodiment if the technical effect associated with this feature is important for a particular application.

In the following, the same reference numerals are used for elements that correspond to each other in terms of structure and/or function.

### BRIEF DESCRIPTION OF THE DRAWINGS

FIG. 1 a schematic perspective view of a plug connector support element according to one possible embodiment;

FIG. 2 a schematic side view of the plug connector support element from FIG. 1;

FIG. 3 a schematic front view of the plug connector support element from FIG. 1;

FIG. 4 a schematic perspective view of a plug connection according to one possible embodiment;

FIG. 5 a schematic side view of the plug connection from FIG. 5;

FIG. 6 a schematic perspective view of a plug connection according to another possible embodiment;

FIG. 7 a schematic perspective view of a plug connector support element according to another possible embodiment;

FIG. 8 a schematic side view of a plug system according to one possible design; and

FIG. 9 a schematic view from below of the connector system from FIG. 8.

### DETAILED DESCRIPTION OF THE INVENTION

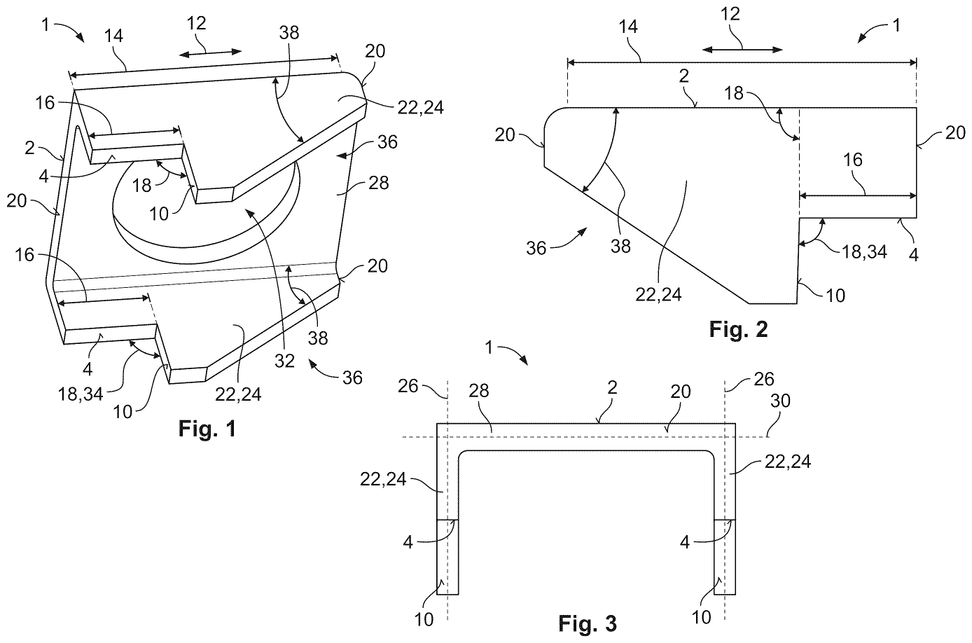

The following section first describes the structure of a plug connector support element according to a possible design with reference to FIGS. 1 to 3.

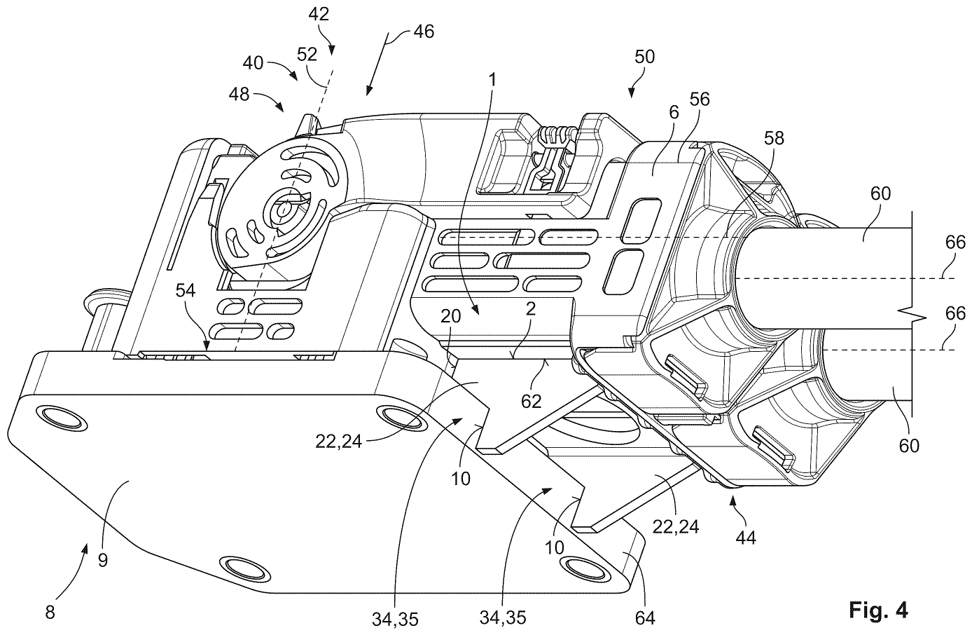

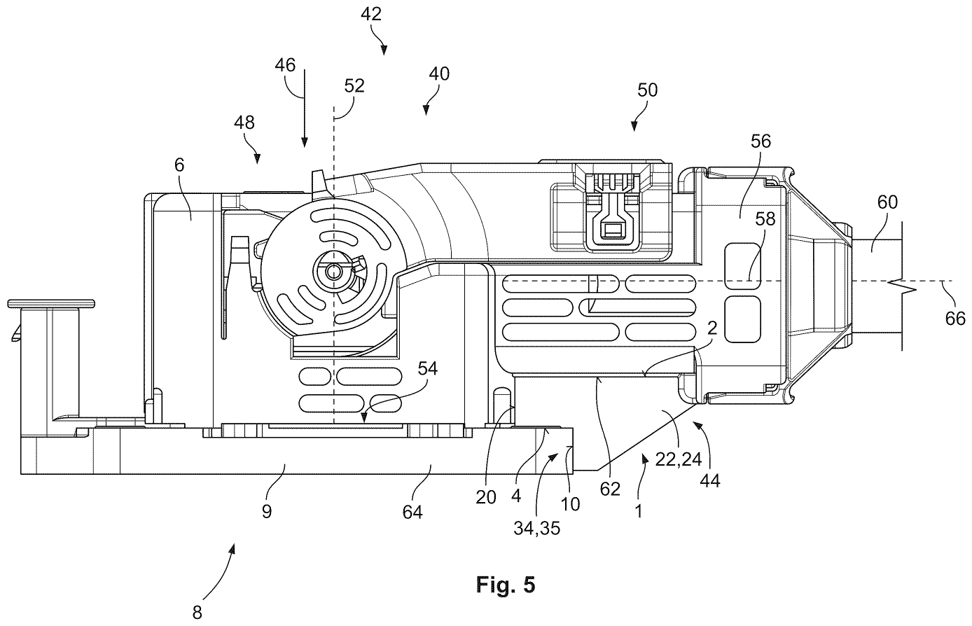

FIGS. 1 to 3 show a plug connector support element 1 with a plug support surface 2 and counter support surfaces 4 opposite the plug support surface 2. The plug support surface 2 is designed to fit against the outside of a plug 6, and the counter support surfaces 4 are designed to fit against the outside of a mating plug arrangement 8. Plug 6 and mating plug arrangement 8 are not shown in FIGS. 1 to 3, but will be explained later with reference to FIGS. 4 and 5.

In the present embodiment, the plug support surface 2 runs parallel to both counter support surfaces 4. As can be seen from FIGS. 1 to 3, the plug support surface 2 can extend beyond the counter support surfaces 4 in at least one direction. The plug support surface 2 can protrude beyond the counter support surfaces 4, preferably on a side of the plug support surface 2 facing away from the torque support surfaces 10. In the embodiment shown, the plug support surface 2 protrudes beyond the counter support surfaces 4, for example, in a width direction 12 of the plug connector support element 1. A width 14 of the plug support surface 2 measured in the width direction 12 is preferably greater than widths 16 of the counter support surfaces 4 measured in the width direction 12. For example, the width 14 of the plug support surface 2 may correspond to between approximately twice and three times the widths 16 of the counter support surfaces 4.

The plug connector support element 1 may further comprise at least one torque support surface 10. The plug connector support element 1 shown in FIGS. 1 to 3 has two torque support surfaces 10 as an example. The torque support surfaces 10 do not necessarily have to extend at an angle 18 to both the plug support surface 2 and both counter support surfaces 4, as shown in FIGS. 1 and 2. Rather, the torque support surfaces 10 may also be arranged at an angle 18 to the plug support surface 2 or to one of the counter support surfaces 4 only. In the present embodiment, both the angle 18 between the torque support surfaces 10 and the plug support surface 2 and the angle 18 between the torque support surfaces 10 and the counter support surfaces 4 are 90°. Of course, other angles 18 other than 90° are also conceivable in other embodiments.

The plug connector support element 1 may also have at least one lateral plug support surface 20. In the embodiment shown in FIGS. 1 to 3, two lateral plug support surfaces 20 are provided purely by way of example, which in this embodiment are opposite each other and extend perpendicular to the plug support surface 2, perpendicular to the counter support surfaces 4 and parallel to the torque support surface 10.

As can also be seen from FIGS. 1 to 3, the plug connector support element 1 may have a support rib 22 and, in some embodiments, at least one further support rib 24. In the embodiment shown, a support rib 22 and a single further support rib 24 are provided as examples, so that a total of two support ribs 22, 24 are present. The support ribs 22, 24 run parallel to each other. In particular, as can be clearly seen in FIG. 3, the center planes 26 spanned by the support ribs 22, 24 can run parallel to each other. Of course, the support ribs 22, 24 do not necessarily have to be identical in design, as shown in the embodiment in FIGS. 1 to 3.

As can also be seen in FIGS. 1 to 3, the support ribs 22, 24 can each extend from the at least one plug support surface 2 to the at least one torque support surface 10. In the embodiment shown, the plug support surface 2 is formed by a plate 28 which connects the support rib 22 to the further support rib 24. In the embodiment shown, the plate 28 extends perpendicular to the support ribs 22, 24, so that—as can be clearly seen in FIG. 3—a center plane 30 of the plate 28 extends perpendicular to the center planes 26 of the support ribs 22, 24. The support ribs 22, 24 and the plate 28 can together form a U-shape.

Of course, in other embodiments, at least one plate 28 may be present without a plug support surface 2 having to be arranged on this at least one plate 28. In this case, the at least one plate 28 may, for example, be arranged completely in the area between the at least one plug support surface 2 and the at least one counter support surface 4.

As can be seen in FIG. 1, the plate 28 may have at least one material cutout 32 in order to improve the handling of the plug connector support element 1 and to save material. The material cutout 32 does not necessarily have to be round, let alone circular, but can also be polygonal, in particular rectangular, and thus, for example, slot-shaped. In other embodiments, the support rib 22 and/or the at least one further support rib 24 may alternatively or cumulatively also be provided with at least one material cutout 32. Of course, in other embodiments, at least two elements from the group of elements comprising the at least one plate 28, the support rib 22 and the at least one further support rib 24 may each have at least one material cutout 32, which may be of the same or different shapes.

In the embodiment shown in FIGS. 1 to 3, the counter support surfaces 4 and the torque support surfaces 10 are arranged on or formed by the support ribs 22, 24 purely by way of example. Of course, at least one counter support surface 4 and/or at least one torque support surface 10 may be formed by another element, for example by the at least one plate 28. In the embodiment shown, a counter support surface 4 and a torque support surface 10, which may be arranged on a common support rib 22, 24, converge at a reception angle 34 and form a corner 35. When the plug connector support element 1 is assembled, at least one section of the mating plug arrangement 8 can be accommodated in each of the corners 35. In other embodiments, the counter support surface 4 and the torque support surface 10 can form reception angles other than 90°.

FIGS. 1 and 2 also show that at least one support rib 22, 24 on at least one side may be inclined or beveled relative to the at least one plug support surface 2 and the at least one torque support surface 10. In the embodiment shown, both support ribs 22, 24 each have a bevel 36 which extends at least in sections between the plug support surface 2 and the torque support surface 10, which extends on the support rib 22, 24 having the bevel 36. The bevels 36 allow forces and moments applied to the plug support surface 2 in the assembled state to be transferred in a mechanically advantageous manner in the direction of the torque support surfaces 10. In the present embodiment, the bevels 36 of both support ribs 22, 24 are inclined at an inclination angle 38 of approximately 30° to the plug support surface 2. Of course, the inclination angle 38 may also be different from 30° in other embodiments and may, for example, be between approximately 15° and approximately 45°.

FIGS. 4 and 5 show the plug connector support element 1 from FIGS. 1 to 3, which is mounted on an electrical plug connector 40. Shown is a plug connection 42 comprising a plug system 44 with a plug 6 and a plug connector support element 1, as well as a mating plug arrangement 8, which in this example comprises a mating plug 9. The plug connector 40 comprises the plug 6 and the mating plug arrangement 8, which is connected to the plug 6 in a mating direction 46. In the present embodiment, the plug 6 comprises, purely by way of example, a plugging section 48 and a cable connecting section 50 projecting transversely to the mating direction 46. The plugging section 48, whose longitudinal axis 52 extends here, for example, along the mating direction 46, accommodates plug contacts via which the plug 6 is connected in an interface 54 to the mating plug arrangement 8 or to its mating plug 9. The plug contacts are covered by a housing 56 of the plug 6 in FIGS. 4 and 5 and are therefore not visible. The cable connecting section 50, whose longitudinal axis 58 in the present embodiment runs perpendicular to the mating direction 46 and perpendicular to the longitudinal axis 52 of the plugging section 48, serves to accommodate at least one cable 60, which in FIGS. 4 and 5 also extends perpendicular to the mating direction 46. The cable 60 is also concealed in the cable connecting section 50 by the housing 56 of the plug 6, but protrudes from the housing 56 of the plug 6 on a side of the cable connecting section 50 facing away from the plugging section 48.

The plug connector support element 1 is mounted on the plug connector 40 in such a way that the plug support surface 2 of the plug connector support element 1 rests flat against the outer support surface of the plug 6, in particular against a support surface 62 of the plug 6 facing in the mating direction 46. In the present embodiment, the support surface 62 of the plug 6 is arranged, for example, in the cable connecting section 50, so that the plug support surface 2 rests against the cable connecting section 50 of the plug 6. In addition, in the embodiment shown, one of the lateral plug support surfaces 20 is exemplarily located on the outside of the plugging section 48, while the other of the lateral plug support surfaces 20 is located on the cable connecting section 50 of the plug 6 (concealed in FIGS. 4 and 5).

Furthermore, in the embodiment shown in FIGS. 4 and 5, both the counter support surfaces 4 and the torque support surfaces 10 of the plug connector support element 1 are located on the outside of the mating plug arrangement 8, in this case, for example, on a plate-shaped flange 64 of the mating plug 9. The mating plug 9 or the flange 64 of the mating plug 9 can be accommodated in the corners 35 having the reception angles 34, which can be formed by the counter support surface 4 and the torque support surface 10 of each of the support ribs 22, 24. By accommodating the plug connector support element 1 in the receiving angles 34, movement of the plug connector support element 1 along the mating direction 46 and in a direction along a longitudinal axis 66 of the cable 60 is prevented in the present embodiment. Of course, in other embodiments, the counter support surfaces 4 and the torque support surfaces 10 do not necessarily have to converge in the receiving angles 34 and form the corners 35.

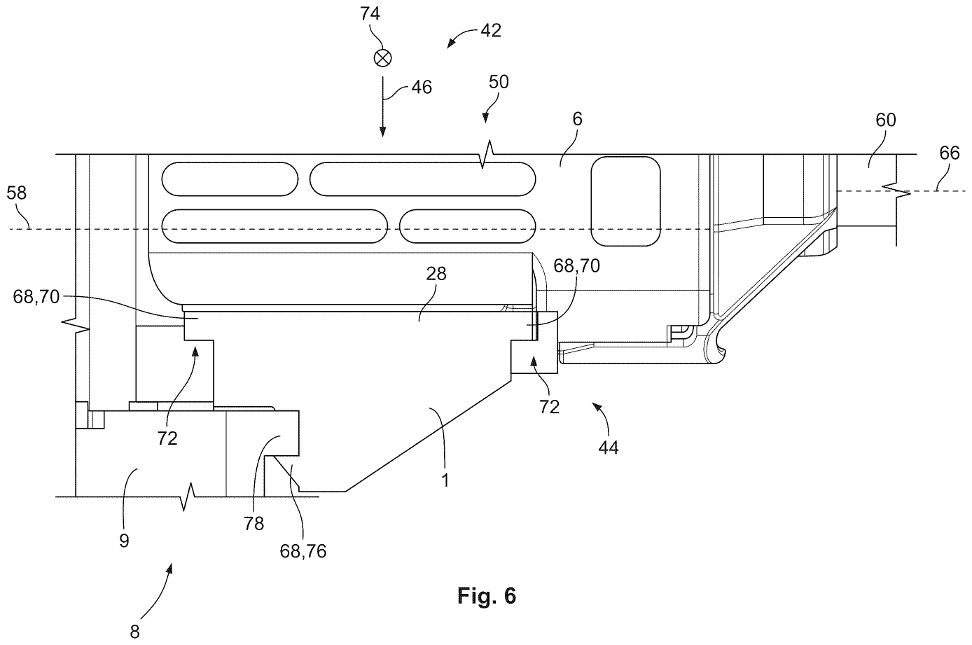

FIG. 6 shows a plug connection 42 according to a further embodiment. The plug system 44 of the plug connection 42 here has a plug connector support element 1 which differs from the embodiment shown in FIGS. 1 to 5. The plug connector support element 1 from FIG. 6 comprises several form-fit elements 68, via which the plug connector support element 1 is connected to the plug 6 or the mating plug 9 of the mating plug arrangement 8.

In this design, two form-fit elements 68 are designed purely as examples as protrusions 70 which can protrude in a direction perpendicular to the mating direction 46 and along the longitudinal axis 66 of the cable 60 or along the longitudinal axis 58 of the cable connecting section 50. The protrusions 70 do not have to be formed by the plate 28 of the plug connector support element 1, as shown in FIG. 6. In the present embodiment, the form-fit elements 68 of the plug connector support element 1, which are designed as protrusions 70, engage in grooves 72 or recesses of the plug 6 that are shaped to complement the protrusions 70, thereby form-fittingly connecting the plug connector support element 1 to the plug 6. In the present embodiment, the plug connector support element 1 can be mounted by inserting it along a mounting direction 74 that runs perpendicular to the insertion direction 46 and perpendicular to the longitudinal axis 58 of the cable connecting section 50.

The plug connector support element 1 may also have a further form-fit element 68, shown here as an example in the form of a locking element 76. As can be seen in FIG. 6, the locking element 76 can engage a protrusion 78 of the mating plug 9 in order to also connect the plug connector support element 1 to the mating plug 9 in a form-fitting manner.

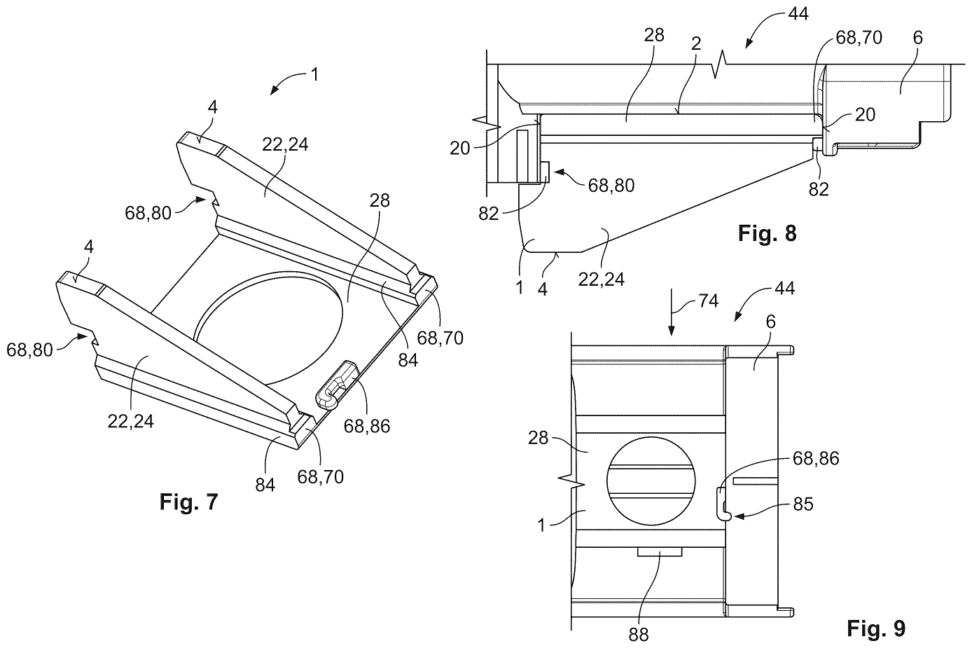

A further embodiment of a plug connector support element 1 or connector system 44 is shown in FIGS. 7 to 9. The plug connector support element 1 shown is essentially similar to the plug connector support element 1 shown in FIGS. 1 to 3, but has several form-fit elements 68 via which the plug connector support element 1 can be connected or is connected to the plug 6. In the present embodiment, each support rib 22, 24 is provided with a form-fit element 68 designed as a recess 80. The form-fit elements 68 of the plug connector support element 1, which are designed as recesses 80, can engage with protrusions 82 of the plug 6 that are shaped to complement the recesses 80, as can be seen in FIG. 8. The plug connector support element 1 may also have further form-fit elements 68 in the form of protrusions 70. In the present embodiment, the protrusions 70 are formed purely by way of example by bases 84, via which the plate 28 is connected to the support ribs 22, 24. FIG. 8 shows that the form-fit elements 68 of the plug connector support element 1, which are formed as protrusions 70, can engage with protrusions 82 of the plug 6 in order to achieve a positive locking connection.

At least one of the form-fit elements 68 of the plug connector support element 1 can be designed as a locking hook 86, which in the present embodiment is arranged, for example, on a side of the plate 28 facing away from the plug support surface 2. Of course, in other embodiments, the locking hook 86 could also be arranged at another location, for example on a support rib 22, 24, on one of the bases 84, on the plug support surface 2, on one of the lateral plug support surfaces 20 or on one of the counter support surfaces 4. As can be seen in FIG. 9, the locking hook 86 can lock into a recess 85 in the plug 6.

As shown in FIG. 9, the plug 6 may also have at least one stop 88 which preferably extends perpendicular to the mounting direction 74. If the plug connector support element 1 is, for example, inserted into the plug 6 along the mounting direction 74 during assembly, the stop 88 prevents the plug connector support element 1 from slipping out of the plug 6 along the mounting direction 74, while the locking hook 86, which is latched with the recess 85 of the plug 6, prevents the plug connector support element 1 from slipping out of the plug 6 in the opposite direction to the mounting direction 74.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Plug connector support element for supporting a plug on a mating plug arrangement mated with the plug, wherein the plug connector support element is configured to be mounted externally between the plug and the mating plug arrangement, the plug connector support element comprising:
at least one plug support surface configured to rest externally on the plug,
and at least one counter support surface opposite the at least one plug support surface, which counter support surface is configured to rest externally on the mating plug arrangement.

2. Plug connector support element according to claim 1,
wherein the plug connector support element has at least one torque support surface arranged at an angle to the at least one plug support surface and/or to the at least one counter support surface.

3. Plug connector support element according to claim 2,
wherein the plug connector support element has a support rib extending from the at least one plug support surface to the at least one torque support surface.

4. Plug connector support element according to claim 3,
wherein the support rib is inclined on at least one side relative to the at least one plug support surface and to the at least one torque support surface and extends from the at least one plug support surface to the at least one torque support surface.

5. Plug connector support element according to claim 3,
with at least one further support rib arranged parallel to the support rib,
and with a plate connecting the at least one support rib to the at least one further support rib.

6. Plug connector support element according to claim 5,
wherein the at least one plug support surface is formed at least in sections by the plate.

7. Plug connector support element according to claim 3,
wherein the plate and/or at least one support rib from the group of support ribs comprising the support rib and the at least one further support rib has at least one material cutout.

8. Plug connector support element according to claim 1,
wherein the at least one plug support surface protrudes beyond the at least one counter support surface.

9. Plug connector support element according to claim 1,
wherein the plug connector support element has at least one form-fit element for connection to the plug and/or the mating plug arrangement.

10. Plug system comprising:
an electrical plug configured to be mateable with a mating plug arrangement in a mating direction, the electrical plug including a support surface facing in the mating direction, and
a plug connector support element including at least one plug support surface and at least one counter support surface opposite the at least one plug support surface,
wherein the at least one counter support surface is configured to rest externally on the mating plug arrangement, and
wherein the at least one plug support surface rests externally on the plug at the support surface of the plug.

11. Plug system according to claim 10,
wherein the plug has a plugging section which receives plug contacts, and a cable connecting section which receives at least one cable and projects from the plugging section transversely to the mating direction,
wherein the at least one plug support surface rests externally on the cable connecting section of the plug.

12. Plug system according to claim 10,
wherein the plug connector support element has at least one form-fit element for connection to the plug and/or the mating plug arrangement, and
wherein the at least one form-fit element is form-fittingly connected to the plug.

13. Plug connection comprising:
a plug system including an electrical plug and a mating plug arrangement, wherein the electrical plug is mateable with a mating plug arrangement in a mating direction, the electrical plug including a support surface facing in the mating direction, and
a plug connector support element including at least one plug support surface and at least one counter support surface opposite the at least one plug support surface, the at least one counter support surface resting externally on the mating plug arrangement, the at least one plug support surface resting externally on the plug at the support surface of the plug.

14. Plug connection according to claim 13,
wherein the at least one torque support surface rests externally on the mating plug arrangement.

15. Plug connection according to claim 13,
wherein the plug has a plugging section which receives plug contacts, and a cable connecting section which receives at least one cable and projects from the plugging section transversely to the mating direction, and
wherein the at least one form-fit element is form-fittingly connected to the mating plug arrangement.
